(19) United States
(12) Patent Application Publication
(10) Pub. No.: US 2015/0006090 A1
(43) Pub. Date: Jan. 1, 2015

(54) STRING SEQUENCING WITH MULTIPLE SEARCH STAGES

(71) Applicant: NVIDIA CORPORATION, Santa Clara, CA (US)

(72) Inventor: Jacopo PANTALEONI, Berlin (DE)

(21) Appl. No.: 13/928,055

(22) Filed: Jun. 26, 2013

(51) Int. Cl. G06F 19/12

(52) U.S. Cl. CPC G06F 19/12
USPC 702/20

(57) ABSTRACT

A sequencing application implements a multi-stage search technique in order to identify locations where a sequence of elements occurs within a much longer reference sequence of elements. The sequencing application breaks the sequence of elements into multiple, possibly overlapping seeds, used to determine all potential occurrences of the sequence in the reference. In order to determine the occurrences of each of the seeds in the reference, the application breaks the seeds into multiple sub-seeds and implements a different search stage for each different short sub-seeds. If a given search stage produces a small number of search results, then the sequencing application determines that each of the occurrences can be tested for a complete match between the entire short read and the reference string, for example using a Smith-Waterman or Needleman-Wunsch algorithm. Otherwise the application attempts to further restrict the determined number of potential occurrences proceeding to the next search stage.

### BACKGROUND OF THE INVENTION

1. Field of the Invention

The present invention generally relates to modeling and analyzing DNA sequences and, more specifically, to string sequencing with multiple search stages.

2. Description of the Related Art

In recent years, various techniques have been developed for determining the precise sequence of base pairs that compose deoxyribonucleic acid (DNA) strands, a process that is known in the art as “DNA sequencing.” A conventional technique involves breaking a strand of DNA into fragments, determining the order of base pairs associated with each fragment, and then reassembling the fragments into the original sequence associated with the strand prior to fragmentation. Once the fragments have been reassembled, the precise sequence of the entire strand of DNA may be identified.

In order to reassemble the fragments back into the original sequence, a string matching algorithm may be implemented in order to identify the locations where each sequence of base pairs associated with each different DNA fragment occurs within a reference sequence of base pairs. In a typical use-case, millions of different DNA fragments must be independently sequenced and then located within the reference sequence. Further, the reference sequence typically includes millions of base pairs. Consequently, DNA sequencing is usually a computationally-intensive task that relies heavily on the performance of the particular string matching algorithm that is implemented in order to operate efficiently.

A conventional string matching algorithm, as applied to DNA sequencing, may operate by identifying potential locations where a given sequence of base pairs associated with a given DNA fragment might occur within the reference sequence. Then, a verification process is performed in order to determine that the given sequence does indeed occur within the reference sequence at those potential locations. However, most conventional string matching algorithms generate a vast multitude of potential locations that must be verified. The large number of verifications required adds to the computational complexity involved with implementing these types of algorithms, thereby decreasing the efficiency and usefulness of string matching algorithms in the context of DNA sequencing.

As the foregoing illustrates, what is needed in the art is a more effective way to determine the location of a string within a reference string in the context of a string matching algorithm.

### SUMMARY OF THE INVENTION

One embodiment of the present invention includes a computer-implemented method for locating a first sequence of elements within a long sequence of elements, including performing a first search operation to identify occurrences of a first sub-sequence of elements derived from the first sequence of elements within the long sequence of elements, generating a first set of occurrence indices representing locations within the long sequence of elements associated with the first sub-sequence of elements, determining that a number of occurrence indices within the first set of occurrence indices exceeds a threshold value associated with a first search stage, performing a second search operation to identify occurrences of a second sub-sequence of elements derived from the first sequence of elements within the long sequence of elements, generating a second set of occurrence indices representing locations within the long sequence of elements associated with the second sub-sequence of elements, and locating the first sequence of elements within the long sequence of elements based on the first set of occurrence indices and based on the second set of occurrence indices.

Advantageously, a strand of DNA may be sequenced faster and more efficiently than possible with conventional DNA sequencing techniques that rely on conventional string matching algorithms.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing subsystem for the computer system of FIG. 1, according to one embodiment of the present invention;

FIG. 3 is a conceptual diagram illustrating a technique performed by the sequencing application shown in FIG. 1, according to one embodiment of the present invention;

FIG. 4 is a more detailed block diagram illustrating the sequencing application shown in FIG. 1, according to one embodiment of the present invention; and

FIG. 5 is a flow diagram of method steps for sequencing an input string that represents an input strand of DNA relative to a reference string that represents a reference strand of DNA, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

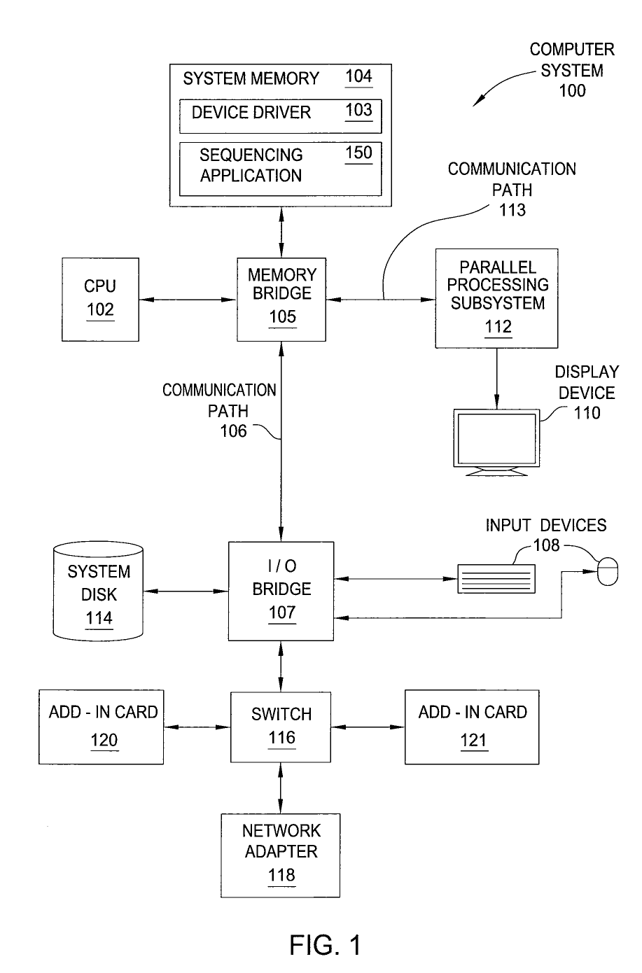

FIG. 1 is a block diagram illustrating a computer system 100 configured to implement one or more aspects of the present invention. Computer system 100 includes a central processing unit (CPU) 102 and a system memory 104 communicating via an interconnection path that may include a memory bridge 105. System memory 104 includes a device driver 103 and a sequencing application 150, as discussed in greater detail below. Memory bridge 105, which may be, e.g., a Northbridge chip, is connected via a bus or other communication path 106 (e.g., a HyperTransport link) to an I/O (input/output) bridge 107. I/O bridge 107, which may be, e.g., a Southbridge chip, receives user input from one or more user input devices 108 (e.g., keyboard, mouse) and forwards the input to CPU 102 via communication path 106 and memory bridge 105. A parallel processing subsystem 112 is coupled to memory bridge 105 via a bus or second communication path 113 (e.g., a Peripheral Component Interconnect (PCI) Express, Accelerated Graphics Port, or HyperTransport link); in one embodiment parallel processing subsystem 112 is a graphics subsystem that delivers pixels to a display device 110 that may be any conventional cathode ray tube, liquid crystal display, light-emitting diode display, or the like. A system disk 114 is also connected to I/O bridge 107 and may be configured to store content and applications and data for use by CPU 102 and parallel processing subsystem 112. System disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices.

A switch 116 provides connections between I/O bridge 107 and other components such as a network adapter 118 and various add-in cards 120 and 121. Other components (not explicitly shown), including universal serial bus (USB) or other port connections, compact disc (CD) drives, digital versatile disc (DVD) drives, film recording devices, and the like, may also be connected to I/O bridge 107. The various communication paths shown in FIG. 1, including the specifically named communication paths 106 and 113 may be implemented using any suitable protocols, such as PCI Express, AGP (Accelerated Graphics Port), HyperTransport, or any other bus or point-to-point communication protocol(s), and connections between different devices may use different protocols as is known in the art.

In one embodiment, the parallel processing subsystem 112 incorporates circuitry optimized for graphics and video processing, including, for example, video output circuitry, and constitutes a graphics processing unit (GPU). In another embodiment, the parallel processing subsystem 112 incorporates circuitry optimized for general purpose processing, while preserving the underlying computational architecture, described in greater detail herein. In yet another embodiment, the parallel processing subsystem 112 may be integrated with one or more other system elements in a single subsystem, such as joining the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some embodiments, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other embodiments, I/O bridge 107 and memory bridge 105 might be integrated into a single chip instead of existing as one or more discrete devices. Large embodiments may include two or more CPUs 102 and two or more parallel processing subsystems 112. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

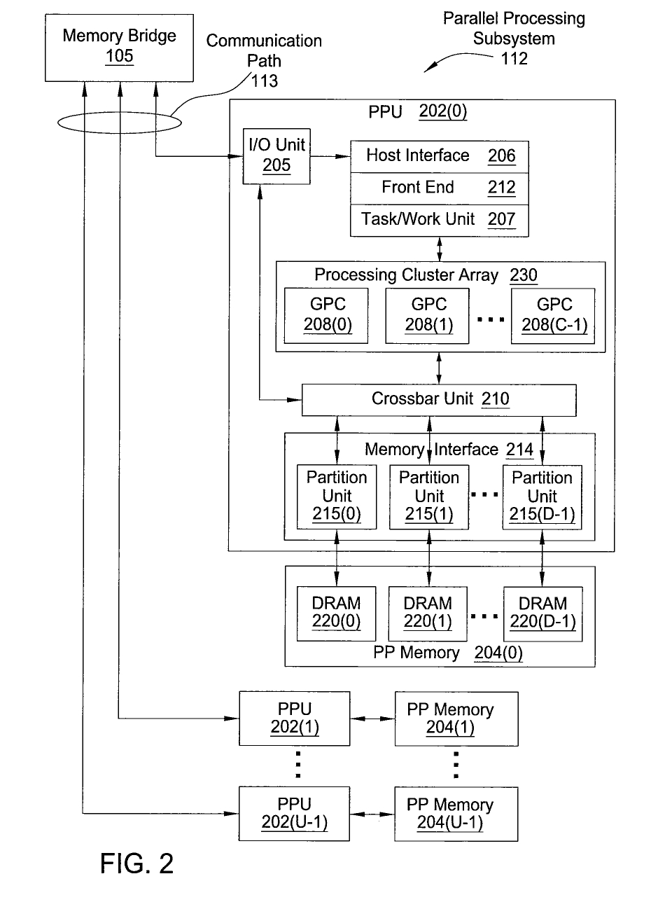

FIG. 2 illustrates a parallel processing subsystem 112, according to one embodiment of the present invention. As shown, parallel processing subsystem 112 includes one or more parallel processing units (PPUs) 202, each of which is coupled to a local parallel processing (PP) memory 204. In general, a parallel processing subsystem includes a number U of PPUs, where U≧1. (Herein, multiple instances of like objects are denoted with reference numbers identifying the object and parenthetical numbers identifying the instance where needed.) PPUs 202 and parallel processing memories 204 may be implemented using one or more integrated circuit devices, such as programmable processors, application specific integrated circuits (ASICs), or memory devices, or in any other technically feasible fashion.

Referring again to FIG. 1 as well as FIG. 2, in some embodiments, some or all of PPUs 202 in parallel processing subsystem 112 are graphics processors with rendering pipelines that can be configured to perform various operations related to generating pixel data from graphics data supplied by CPU 102 and/or system memory 104 via memory bridge 105 and the second communication path 113, interacting with local parallel processing memory 204 (which can be used as graphics memory including, e.g., a conventional frame buffer) to store and update pixel data, delivering pixel data to display device 110, and the like. In some embodiments, parallel processing subsystem 112 may include one or more PPUs 202 that operate as graphics processors and one or more other PPUs 202 that are used for general-purpose computations. The PPUs may be identical or different, and each PPU may have a dedicated parallel processing memory device(s) or no dedicated parallel processing memory device(s). One or more PPUs 202 in parallel processing subsystem 112 may output data to display device 110 or each PPU 202 in parallel processing subsystem 112 may output data to one or more display devices 110.

In operation, CPU 102 is the master processor of computer system 100, controlling and coordinating operations of other system components. In particular, CPU 102 issues commands that control the operation of PPUs 202. In some embodiments, CPU 102 writes a stream of commands for each PPU 202 to a data structure (not explicitly shown in either FIG. 1 or FIG. 2) that may be located in system memory 104, parallel processing memory 204, or another storage location accessible to both CPU 102 and PPU 202. A pointer to each data structure is written to a pushbuffer to initiate processing of the stream of commands in the data structure. The PPU 202 reads command streams from one or more pushbuffers and then executes commands asynchronously relative to the operation of CPU 102. Execution priorities may be specified for each pushbuffer by an application program via the device driver 103 to control scheduling of the different pushbuffers.

Referring back now to FIG. 2 as well as FIG. 1, each PPU 202 includes an I/O (input/output) unit 205 that communicates with the rest of computer system 100 via communication path 113, which connects to memory bridge 105 (or, in one alternative embodiment, directly to CPU 102). The connection of PPU 202 to the rest of computer system 100 may also be varied. In some embodiments, parallel processing subsystem 112 is implemented as an add-in card that can be inserted into an expansion slot of computer system 100. In other embodiments, a PPU 202 can be integrated on a single chip with a bus bridge, such as memory bridge 105 or I/O bridge 107. In still other embodiments, some or all elements of PPU 202 may be integrated on a single chip with CPU 102.

In one embodiment, communication path 113 is a PCI Express link, in which dedicated lanes are allocated to each PPU 202, as is known in the art. Other communication paths may also be used. An I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to parallel processing memory 204) may be directed to a memory crossbar unit 210. Host interface 206 reads each pushbuffer and outputs the command stream stored in the pushbuffer to a front end 212.

Each PPU 202 advantageously implements a highly parallel processing architecture. As shown in detail, PPU 202(0) includes a processing cluster array 230 that includes a number C of general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary dependent on the workload arising for each type of program or computation.

GPCs 208 receive processing tasks to be executed from a work distribution unit within a task/work unit 207. The work distribution unit receives pointers to processing tasks that are encoded as task metadata (TMD) and stored in memory. The pointers to TMDs are included in the command stream that is stored as a pushbuffer and received by the front end unit 212 from the host interface 206. Processing tasks that may be encoded as TMDs include indices of data to be processed, as well as state parameters and commands defining how the data is to be processed (e.g., what program is to be executed). The task/work unit 207 receives tasks from the front end 212 and ensures that GPCs 208 are configured to a valid state before the processing specified by each one of the TMDs is initiated. A priority may be specified for each TMD that is used to schedule execution of the processing task. Processing tasks can also be received from the processing cluster array 230. Optionally, the TMD can include a parameter that controls whether the TMD is added to the head or the tail for a list of processing tasks (or list of pointers to the processing tasks), thereby providing another level of control over priority.

Memory interface 214 includes a number D of partition units 215 that are each directly coupled to a portion of parallel processing memory 204, where D≧1. As shown, the number of partition units 215 generally equals the number of dynamic random access memory (DRAM) 220. In other embodiments, the number of partition units 215 may not equal the number of memory devices. Persons of ordinary skill in the art will appreciate that DRAM 220 may be replaced with other suitable storage devices and can be of generally conventional design. A detailed description is therefore omitted. Render targets, such as frame buffers or texture maps may be stored across DRAMs 220, allowing partition units 215 to write portions of each render target in parallel to efficiently use the available bandwidth of parallel processing memory 204.

Any one of GPCs 208 may process data to be written to any of the DRAMs 220 within parallel processing memory 204. Crossbar unit 210 is configured to route the output of each GPC 208 to the input of any partition unit 215 or to another GPC 208 for further processing. GPCs 208 communicate with memory interface 214 through crossbar unit 210 to read from or write to various external memory devices. In one embodiment, crossbar unit 210 has a connection to memory interface 214 to communicate with I/O unit 205, as well as a connection to local parallel processing memory 204, thereby enabling the processing cores within the different GPCs 208 to communicate with system memory 104 or other memory that is not local to PPU 202. In the embodiment shown in FIG. 2, crossbar unit 210 is directly connected with I/O unit 205. Crossbar unit 210 may use virtual channels to separate traffic streams between the GPCs 208 and partition units 215.

Again, GPCs 208 can be programmed to execute processing tasks relating to a wide variety of applications, including but not limited to, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel shader programs), and so on. PPUs 202 may transfer data from system memory 104 and/or local parallel processing memories 204 into internal (on-chip) memory, process the data, and write result data back to system memory 104 and/or local parallel processing memories 204, where such data can be accessed by other system components, including CPU 102 or another parallel processing subsystem 112.

A PPU 202 may be provided with any amount of local parallel processing memory 204, including no local memory, and may use local memory and system memory in any combination. For instance, a PPU 202 can be a graphics processor in a unified memory architecture (UMA) embodiment. In such embodiments, little or no dedicated graphics (parallel processing) memory would be provided, and PPU 202 would use system memory exclusively or almost exclusively. In UMA embodiments, a PPU 202 may be integrated into a bridge chip or processor chip or provided as a discrete chip with a high-speed link (e.g., PCI Express) connecting the PPU 202 to system memory via a bridge chip or other communication means.

As noted above, any number of PPUs 202 can be included in a parallel processing subsystem 112. For instance, multiple PPUs 202 can be provided on a single add-in card, or multiple add-in cards can be connected to communication path 113, or one or more of PPUs 202 can be integrated into a bridge chip. PPUs 202 in a multi-PPU system may be identical to or different from one another. For instance, different PPUs 202 might have different numbers of processing cores, different amounts of local parallel processing memory, and so on. Where multiple PPUs 202 are present, those PPUs may be operated in parallel to process data at a higher throughput than is possible with a single PPU 202. Systems incorporating one or more PPUs 202 may be implemented in a variety of configurations and form factors, including desktop, laptop, or handheld personal computers, servers, workstations, game consoles, embedded systems, and the like.

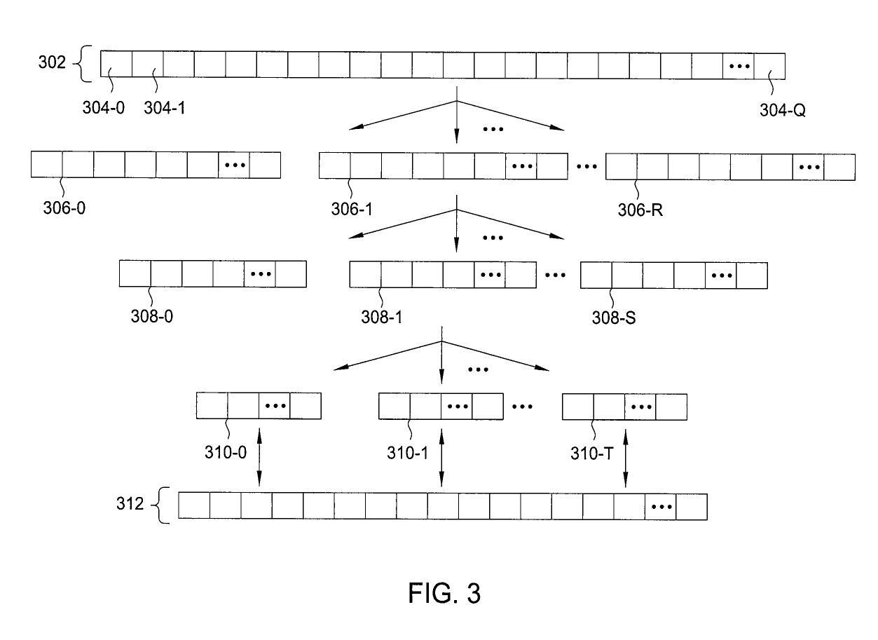

Parallel processing subsystem 112 is configured to execute sequencing application 150 shown in FIG. 1. Sequencing application 150 is a software application configured to sequence an input string by implementing multiple search stages, as described in greater detail below in conjunction with FIG. 3. Sequencing application 150 is configured to be executed across multiple, parallel threads on parallel processing subsystem 112. In practice, each PPU 202 within parallel processing subsystem 112 may execute multiple threads associated with sequencing application 150 in parallel, each GPC 208 within a given PPU 202 may execute multiple threads associated with sequencing application 150 in parallel, and each of multiple processing cores (not shown) within a given GPC 208 may execute multiple threads associated with sequencing application 150 in parallel. Accordingly, any of the different processing operations described below in conjunction with FIGS. 3-5 may be performed by one or more threads while, simultaneously, one or more other threads may perform any of the other processing operations described below.

### String Sequencing with Multiple Search Stages

As is known in the art, DNA sequencing relies on algorithms designed to search a reference sequence to identify particular locations where other, shorter sub-sequences occur. For example, an input strand of DNA may be sequenced by breaking that strand into fragments, determining the sequence of base pairs associated with each fragment, and then searching a reference sequence that represents the input strand to identify locations where those base pair sequences occur. The base pair sequences may then be reassembled into the original sequence associated with the input strand according to the identified locations, thereby providing the complete sequence of that original strand.

Such algorithms typically draw from a broad class of algorithms known in computer science as “string matching” algorithms. In this context, a “string” is a fundamental data type that represents a sequence of elements. The following description sets forth a technique for sequencing a string with multiple search stages. The elements within any sequence described herein could represent base pairs in the context of DNA sequencing applications, letters of the alphabet in the context of text searching applications, or other elements in the context of other applications. Although the following description sets forth a string sequencing technique as applied to DNA sequencing, persons skilled in the art will recognize that the technique set forth may be applied to string sequencing in other contexts as well.

FIG. 3 is a conceptual diagram illustrating a technique performed by the sequencing application 150 shown in FIG. 1, according to one embodiment of the present invention. Sequencing application 150 is a software application configured to determine the sequence of elements 304 within input string 302. As shown, input string 302 includes elements 304, such as, e.g. element 304-0, element 304-1, or element 304-Q. In the exemplary embodiment discussed herein, input string 302 includes Q elements, Q being a positive integer. In embodiments where input string 302 represents a strand of DNA, each element 304 could represent a nucleotide associated with one of the fundamental base pairs (i.e. A, C, T, or G).

Sequencing application 150 is configured to generate short reads 306-0 and 306-1 through 306-R based on input string 302. In the exemplary embodiment discussed herein, sequencing application 150 generates R short reads, R being a positive integer. Short reads 306 represent portions of input string 302 and include elements 304 derived from input string 302. Each short read 306 could include any number of elements 304 present in input string 302. Sequencing application 150 may generate short reads 306 by dividing input string 302 into R different consecutive sequences, or by dividing input string 302 into R overlapping sequences, among other potential ways to divide a sequence of elements.

Once sequencing application 150 has generated short reads 306, sequencing application 150 may then generate seeds 308-0 and 308-1 through 308-S. In the exemplary embodiment discussed herein, sequencing application 150 generates S seeds 308, S being a positive integer, for each short read 306. For the sake of simplicity, only the S seeds 308 generated based on short read 306-1 are shown in FIG. 3. However, in practice, sequencing application 150 is configured to generate a different set of seeds 308, having potentially any number of seeds 308, for each short read 306.

Seeds 308 represent portions of short read 306-1 and include elements 304 derived from short read 306-1. Each seed 308 could include any number of elements 304 present in short read 306-1. Sequencing application 150 may generate seeds 308 by dividing short read 306-1 into S different consecutive sequences, or by dividing short read 306-1 into S overlapping sequences, among other potential ways to divide a sequence of elements.

Once sequencing application 150 has generated seeds 308, sequencing application 150 may then generate seed fragments 310-0 and 310-1 through 310-T. In the exemplary embodiment discussed herein, sequencing application 150 generates T seed fragments 310, T being a positive integer, for each seed 308. For the sake of simplicity, only the T seed fragments 310 generated based on seed 308-1 are shown in FIG. 3. However, in practice, sequencing application 150 is configured to generate a different set of seed fragments 310, having potentially any number of seed fragments 310, for each seed 308.

Seed fragments 310 represent portions of seed 308-1 and include elements 304 derived from seed 308-1. Each seed fragment 310 could include any number of elements 304 present in seed 308-1. Sequencing application 150 may generate seed fragments 310 by dividing seed 308-1 into T different consecutive sequences, or by dividing seed 308-1 into T overlapping sequences, among other potential ways to divide a sequence of elements.

Once sequencing application 150 has generated seed fragments 310 based on seed 308-1, sequencing application 150 may identify locations within a reference string 312 where seed 308-1 occurs by sequentially searching that reference string for occurrences of seed fragments 310. In the exemplary embodiment shown in FIG. 3, sequencing application 150 is configured to search reference string 312 for instances of seed fragment 310-0, then search reference string 312 for instances of seed fragment 310-1, and so forth sequentially, until finally searching reference string 312 for seed fragment 310-T. Each such sequential search operation is referred to herein as a “search stage.”

At each different search stage, sequencing application 150 may implement a different search algorithm. At any given search stage, sequencing application 150 may implement a suffix array or an FM-index based filter, a Smith-Waterman or a Needleman-Wunsch verification algorithm, or any other type of exact or fuzzy string matching algorithm. For example, sequencing application 150 could implement an FM-index at a first search stage in order to identify exactly matching occurrences of seed fragment 310-0 within reference string 312, then implement a Smith-Waterman algorithm at a second search stage to identify approximately matching occurrences of seed fragment 310-1 within reference string 312. When identifying approximately matching occurrences of seed fragment 310-1, sequencing application 150 may implement a fuzzy string matching algorithm in order to allow for transcription errors that may be introduced when sequencing application 150 generates short reads 306. Sequencing application 150 may also implement a fuzzy string matching algorithm at various different search stages in order to allow for differences between input strand 302 and reference strand 312.

Sequencing application 150 may also be configured to implement different search stages with progressively longer sub-sequences of seed 308-1. For example, sequencing application 150 could implement a first search stage with seed fragment 310-0 that represents the first U elements 304 within seed fragment 308-1, then implement a second search stage with seed fragment 310-1 that represents the first U+V elements 304 of seed 308-1, where U and V would both be positive integers. In this example, sequencing application 150 could implement a sequence-extending algorithm, such as e.g. Smith-Waterman or Needleman-Wunsch, etc., at sequential search stages in order to search for progressively longer seed fragments 310.

In addition, when implementing a given search stage in order to search for a particular seed fragment 310, sequencing application 150 may determine whether to proceed to a subsequent search stage based on the results of the given search stage. For example, if sequencing application 150 determines that implementing a first search stage has failed to identify any occurrences of seed fragment 310-0 within reference string 312, sequencing application 150 may then forego implementing a second search stage in order to search for seed fragment 310-1. Since seed fragment 310-0 was not found within reference string 312, sequencing application 150 need not perform additional search stages and may simply determine that seed 308-1 as a whole does not appear within reference string 312.

In addition, each different search stage may be associated with a different threshold that represents a minimum number of occurrences of a corresponding seed fragment 310 needed to proceed to a subsequent search stage. When sequencing application 150 determines that a given search stage did not generate a sufficient number of results (i.e., based on the threshold associated with that search stage), then sequencing application 150 may forego implementing additional search stages in order to search for seed fragment 310-1 and determine that each of the occurrences can be tested for a complete match between the entire short read and the reference string, for example using a Smith-Waterman or Needleman-Wunsch algorithm.

Sequencing application 150 is configured to implement a search stage with each different seed fragment 310 in order to identify locations within reference string 312 where those seed fragments 310 occur. Sequencing application 150 may express any locations produced by a search stage as “occurrence indices” that reflect indices where a given seed fragment 310 processed by the search stage begins within reference string 312. Sequencing application 150 is configured to process the set of seed fragments 310 associated with each seed 308 and generate a set of occurrence indices for each seed 308. Sequencing application 150 may then identify locations within reference string 312 where a given seed 308 occurs based on the set of occurrence indices generated for that seed 308.

Sequencing application 150 may also proceed in similar fashion relative to short reads 306 in order to identify locations within reference string 312 where each short read 306 occurs. For a given short read 306, sequencing application 150 may identify locations within reference sequence 312 where that short read 306 occurs based on identified locations within reference string 312 associated with seeds 308 previously derived from the given short read 306. Finally, sequencing application 150 may reconstruct at least a portion of the original sequence of elements 304 associated with input string 302 based on short reads 306 and the identified locations of those short reads 306 within reference string 312.

In one embodiment, sequencing application 150 is configured to perform various operations associated with the techniques described above in parallel with various other operations associated with those techniques. For example, sequencing application 150 could implement a first search stage with one seed fragment 310 while simultaneously implementing the first search stage with a different seed fragment 310. Persons skilled in the art will recognize that the techniques described herein are well-suited to be implemented by the parallel processing architecture described in conjunction with FIGS. 1-2, and that any implementation of those techniques, parallel or otherwise, falls within the scope of the present invention.

Persons skilled in the art will recognize that the techniques described herein may be implemented across many different threads and/or processing cores associated with parallel processing subsystem 112. For example, each search stage described above may be implemented for many different seed fragments 310 in parallel across many different threads and/or processing cores. By implementing the aforementioned techniques within the parallel processing architecture described above in conjunction with FIGS. 1-2, a strand of DNA may be quickly and efficiently sequenced.

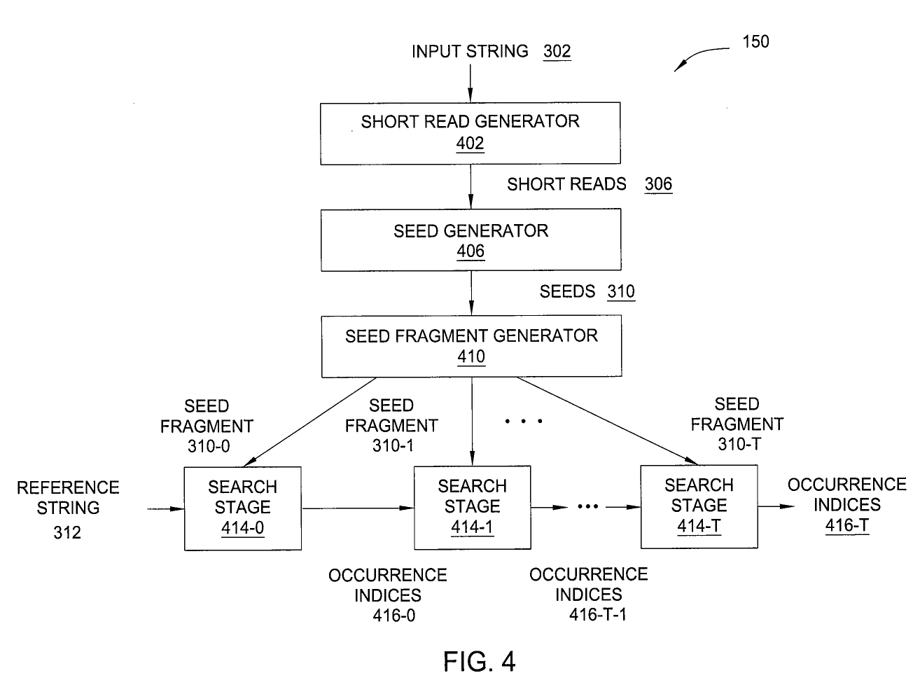

FIG. 4 is a more detailed block diagram illustrating the sequencing application shown in FIG. 1, according to one embodiment of the present invention. As shown, sequencing application 150 includes a short read generator 402, a seed generator 406, a seed fragment generator 410, and multiple different search stages 414-0 and 414-1 through 414-T. Short read generator 402 is configured to receive input string 302 and to then generate short reads 306. Seed generator 406 is configured to receive short reads 306 from short read generator 402 and to then generate seeds 308. Seed fragment generator 410 is configured to receive seeds 308 from seed generator 406 and to then generate seed fragments 310-0 and 310-1 through 310-T.

Search stage 414-0 may then implement a first search algorithm in order to search for occurrences of seed fragment 310-0 within reference string 312. Search stage 414-0 may produce occurrence indices 416-0 that represent locations within reference string 312 where seed fragment 310-0 occurs. Search stage 414-0 may implement any technically feasible string matching algorithm, such as, e.g., suffix array, FM-index, or others, as mentioned previously. Search stage 414-0 may be associated with a threshold, and in situations where the number of occurrence indices 416-0 does not exceed that threshold, sequencing application 150 may not proceed to subsequent search stages 414 and determine that each of the occurrences can be tested for a complete match between the entire short read and the reference string, for example using a Smith-Waterman or Needleman-Wunsch algorithm.

However, if sequencing application 150 determines that sufficient occurrence indices 416-0 were produced, then sequencing application 150 may proceed with implementing search stage 414-1. Search stage 414-1 may then implement a second search algorithm in order to search for occurrences of seed fragment 310-1 within reference string 312. Search stage 414-1 may produce occurrence indices 416-1 that represent locations within reference string 312 where seed fragment 310-1 occurs. Search stage 414-1 may implement any technically feasible string matching algorithm and may also be associated with a threshold, similar to search stage 414-0.

Sequencing application 150 may proceed in similar fashion for search stage 414-T with seed fragment 310-T in order to generate occurrence indices 416-T. In general, sequencing application 150 may proceed in similar fashion for multiple different search stages 414, where each search stage 414 may be associated with a different string matching algorithm and a different threshold. For a given seed 308 and associated seed fragments 310, if each search stage 414 generates a small number of occurrence indices 416, then sequencing application 150 may determine to directly verify the entire short read against the reference at any of the identified locations, or otherwise proceed to the next search stage to further restrict the number of identified occurrences.

Persons skilled in the art will recognize that the different modules shown in FIG. 4 may be implemented across many different threads and/or processing cores associated with parallel processing subsystem 112. For example, search stages 414 may be implemented for many different seed fragments 310 in parallel across many different threads and/or processing cores. By implementing the techniques described herein within the parallel processing architecture described above in conjunction with FIGS. 1-2, a strand of DNA may be quickly and efficiently sequenced.

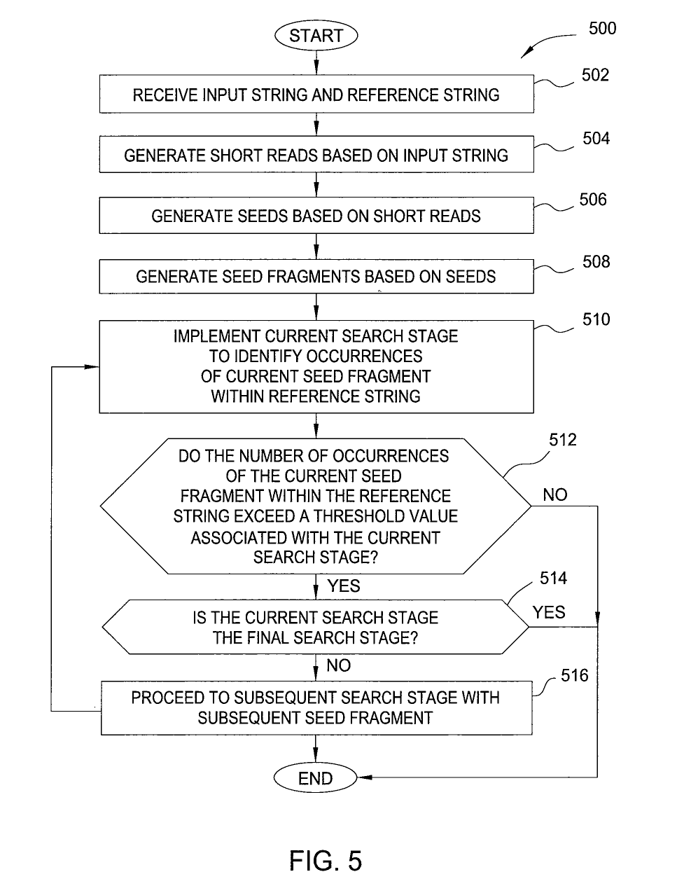

FIG. 5 is a flow diagram of method steps for sequencing an input string that represents an input strand of DNA relative to a reference string that represents a reference strand of DNA, according to one embodiment of the present invention. Although the method steps are described in conjunction with the systems of FIGS. 1-4, persons skilled in the art will understand that any system configured to perform the method steps, in any order, is within the scope of the present invention.

As shown, a method 500 begins at step 502, where sequencing application 150 receives input string 302 and reference string 312. Input string 302 and reference string 312 may both represent strands of DNA or sequences of elements 304 derived from strands of DNA. At step 504, sequencing application 150 generates short reads 306 based on input string 302. Sequencing application 150 could, for example, implement short read generator 402 to generate short reads 306. At step 506, sequencing application 150 generates seeds 308 based on short reads 306. Sequencing application 150 could, for example, implement seed generator 406 to generate seeds 308. At step 508, sequencing application 150 generates seed fragments 310 based on seeds 308. Sequencing application 150 could, for example, implement seed fragment generator 410 to generate seed fragments 310.

At step 510, sequencing application 150 implements a search stage 414 to identify occurrences of a seed fragment 310 within reference string 312. At step 512, sequencing application 150 determines whether the number of occurrences of the seed fragment 310 within reference string 312 exceeds a threshold value associated with the search stage 414.

If sequencing application 150 determines at step 512 that the number of occurrences of seed fragment 310 within reference string 312 does not exceed the threshold value, then the method 500 ends, and sequencing application 150 determines that the seed 308 associated with seed fragment 310 does not occur within reference string 312.

If sequencing application 150 determines at step 512 that the number of occurrences of the seed fragment within reference string 312 does exceed the threshold value, then the method 500 proceeds to step 514. At step 514, sequencing application 150 determines whether the current search stage 414 is the final search stage.

If sequencing application 150 determines at step 514 that the current search stage 414 is the final search stage, then the method 500 ends. Otherwise, if sequencing application 150 determines at step 514 that the current search stage 414 is not the final search stage, then the method 500 proceeds to step 516. At step 516, sequencing application 150 proceeds to a subsequent search stage 414. The method 500 then returns to step 510 and proceeds as described above relative to the subsequent search stage with a subsequent seed fragment 310.

In one embodiment, sequencing application 150 may perform steps 502, 504, 506, and 508 once, then perform steps 510, 512, 514, and 516 multiple times in parallel with different seed fragments. Persons skilled in the art will recognize that various different portions of the method 500 may be implemented in parallel with other portions of the method 500. Again, aspects of the systems described in FIGS. 1 and 2 above are well-suited for such parallel processing operations.

In sum, a sequencing application implements a multi-stage search technique in order to identify locations where a sequence of elements occurs within a much longer reference sequence of elements. The sequencing application breaks the sequence of elements into multiple short sequences of elements, and then implements a different search stage for each different short sequence of elements. If a given search stage produces a small number of search results, then the sequencing application determines that each of the occurrences can be tested for a complete match between the entire short read and the reference string, for example using a Smith-Waterman or Needleman-Wunsch algorithm. Otherwise the application attempts to further restrict the determined number of potential occurrences proceeding to the next search stage.

Advantageously, a strand of DNA may be sequenced faster and more efficiently than possible with conventional DNA sequencing techniques that rely on conventional string matching algorithms.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed is:

1. A computer-implemented method for locating a first sequence of elements within a long sequence of elements, the method comprising:
performing a first search operation to identify occurrences of a first sub-sequence of elements derived from the first sequence of elements within the long sequence of elements;
generating a first set of occurrence indices representing locations within the long sequence of elements associated with the first sub-sequence of elements;
determining that a number of occurrence indices within the first set of occurrence indices exceeds a threshold value associated with a first search stage;
performing a second search operation to identify occurrences of a second sub-sequence of elements derived from the first sequence of elements within the long sequence of elements;
generating a second set of occurrence indices representing locations within the long sequence of elements associated with the second sub-sequence of elements; and
locating the first sequence of elements within the long sequence of elements based on the first set of occurrence indices and based on the second set of occurrence indices.

2. The computer-implemented method of claim 1, further comprising determining that a number of occurrence indices within the second set of occurrence indices exceeds a threshold value associated with the second search stage to determine that the first sequence of elements is located within the long sequence of elements.

3. The computer implemented method of claim 1, wherein performing the first search operation comprises executing a suffix-array search algorithm or executing an FM-index search algorithm to identify the occurrences of the first subsequence of elements within the long sequence of elements.

4. The computer implemented method of claim 1, wherein performing the first search operation comprises executing a Smith-Waterman search algorithm or a Needleman-Wunsch search algorithm to identify the occurrences of the first subsequence of elements within the long sequence of elements.

5. The computer implemented method of claim 1, wherein performing the second search operation comprises executing a suffix-array search algorithm or executing an FM-index search algorithm to identify the occurrences of the second subsequence of elements within the long sequence of elements.

6. The computer implemented method of claim 1, wherein performing the second search operation comprises executing a Smith-Waterman search algorithm or a Needleman-Wunsch search algorithm to identify the occurrences of the second subsequence of elements within the long sequence of elements.

7. The computer implemented method of claim 1, wherein performing the first search operation comprises executing an exact string matching algorithm to identify the occurrences of the first subsequence of elements within the long sequence of elements and performing the second search operation comprises executing a fuzzy string matching algorithm to identify the occurrences of the second subsequence of elements within the long sequence of elements.

8. The computer-implemented method of claim 1, wherein the first sub-sequence of elements and the second sub-sequence of elements are included within a seed that is represented by the first sequence of elements, the seed comprises a portion of a short read, the short read comprises a sequence of base pairs associated with a portion of a strand of deoxyribonucleic acid (DNA), and the long sequence of elements comprises a sequence of base pairs associated with a reference strand of DNA.

9. A non-transitory computer-readable medium storing program instructions that, when executed by a processing unit, cause the processing unit to locate a first sequence of elements within a long sequence of elements by performing the steps of:
performing a first search operation to identify occurrences of a first sub-sequence of elements derived from the first sequence of elements within the long sequence of elements;
generating a first set of occurrence indices representing locations within the long sequence of elements associated with the first sub-sequence of elements;
determining that a number of occurrence indices within the first set of occurrence indices exceeds a threshold value associated with a first search stage;
performing a second search operation to identify occurrences of a second sub-sequence of elements derived from the first sequence of elements within the long sequence of elements;
generating a second set of occurrence indices representing locations within the long sequence of elements associated with the second sub-sequence of elements; and
locating the first sequence of elements within the long sequence of elements based on the first set of occurrence indices and based on the second set of occurrence indices.

10. The non-transitory computer-readable medium of claim 9, further comprising determining that a number of occurrence indices within the second set of occurrence indices exceeds a threshold value associated with the second search stage to determine that the first sequence of elements is located within the long sequence of elements.

11. The non-transitory computer-readable medium of claim 9, wherein performing the first search operation comprises executing a suffix-array search algorithm or executing an FM-index search algorithm to identify the occurrences of the first subsequence of elements within the long sequence of elements.

12. The non-transitory computer-readable medium of claim 9, wherein performing the first search operation comprises executing a Smith-Waterman search algorithm or a Needleman-Wunsch search algorithm to identify the occurrences of the first subsequence of elements within the long sequence of elements.

13. The non-transitory computer-readable medium of claim 9, wherein performing the second search operation comprises executing a suffix-array search algorithm or executing an FM-index search algorithm to identify the occurrences of the second subsequence of elements within the long sequence of elements.

14. The non-transitory computer-readable medium of claim 9, wherein performing the second search operation comprises executing a Smith-Waterman search algorithm or a Needleman-Wunsch search algorithm to identify the occurrences of the second subsequence of elements within the long sequence of elements.

15. The non-transitory computer-readable medium of claim 9, wherein performing the first search operation comprises executing an exact string matching algorithm to identify the occurrences of the first subsequence of elements within the long sequence of elements and performing the second search operation comprises executing a fuzzy string matching algorithm to identify the occurrences of the second subsequence of elements within the long sequence of elements.

16. The non-transitory computer-readable medium of claim 9, wherein the first sub-sequence of elements and the second sub-sequence of elements are included within a seed that is represented by the first sequence of elements, the seed comprises a portion of a short read, the short read comprises a sequence of base pairs associated with a portion of a strand of deoxyribonucleic acid (DNA), and the long sequence of elements comprises a sequence of base pairs associated with a reference strand of DNA.

17. A computing device configured to locate a first sequence of elements within a long sequence of elements, including:
a processing unit configured to:
perform a first search operation to identify occurrences of a first sub-sequence of elements derived from the first sequence of elements within the long sequence of elements,
generate a first set of occurrence indices representing locations within the long sequence of elements associated with the first sub-sequence of elements,
determine that a number of occurrence indices within the first set of occurrence indices exceeds a threshold value associated with a first search stage,
perform a second search operation to identify occurrences of a second sub-sequence of elements derived from the first sequence of elements within the long sequence of elements,
generate a second set of occurrence indices representing locations within the long sequence of elements associated with the second sub-sequence of elements, and
locate the first sequence of elements within the long sequence of elements based on the first set of occurrence indices and based on the second set of occurrence indices.

18. The computing device of claim 17, further including:
a memory unit coupled to the processing unit and storing program instructions that, when executed by the processing unit, cause the processing unit to:
perform the first search operation,
generate the first set of occurrence indices,
determine that the number of occurrence indices within the first set of occurrence indices exceeds the threshold value,
perform the second search operation,
generate the second set of occurrence indices, and
locate the first sequence of elements within the long sequence of elements.

19. The computing device of claim 18, wherein the processing unit is further configured to determine that a number of occurrence indices within the second set of occurrence indices exceeds a threshold value associated with the second search stage to determine that the first sequence of elements is located within the long sequence of elements.

20. The computing device of claim 18, wherein the processing unit is further configured to perform the first search operation by executing an exact string matching algorithm to identify the occurrences of the first subsequence of elements within the long sequence of elements and perform the second search operation by executing a fuzzy string matching algorithm to identify the occurrences of the second subsequence of elements within the long sequence of elements.
